(19) United States
(12) Patent Application Publication
(10) Pub. No.: US 2026/0253278 A1
(43) Pub. Date: Aug. 27, 2026

(54) ENHANCING SECURITY FOR IMAGE-CENTRIC ARTIFICIAL INTELLIGENCE MODELS WITH GUARDRAIL PATCHES

(71) Applicant: INTUIT INC., Mountain View, CA (US)

(72) Inventors: Idan HABLER, Be'er Ya'akov (IL); Jonathan RABIN, Kfar Saba (IL); Itsik Yizhak MANTIN, Shoham (IL); Yael Mathov GOME, Be'er Sheva (IL)

(21) Appl. No.: 19/060,211

(22) Filed: Feb. 21, 2025

(51) Int. Cl. G06T 11/60

(52) U.S. Cl. CPC G06T 11/60

(57) ABSTRACT

Aspects of the present disclosure relate to securing image processing machine learning models. Embodiments include receiving an input image. Embodiments further include injecting a protective patch into the input image to produce a patched image, wherein the protective patch comprises security instructions that prevent an image processing machine learning model from performing a target action. Embodiments further include providing the patched image to the image processing machine learning model. Embodiments further include receiving an output from the image processing machine learning model based on the patched image.

### INTRODUCTION

Aspects of the present disclosure relate to techniques for securing image processing machine learning models. In particular, techniques described herein involve injecting patches into images that are provided as input to an image processing machine learning model. A patch may comprise instructions that prevent the image processing machine learning model from performing a target undesirable action, such as revealing protected information.

### BACKGROUND

A growing number of people, businesses, and organizations around the world rely on machine learning models for performing tasks related to images and text. For example, image processing machine learning models may be used to classify images, extract text from images, and automate countless other tasks that would otherwise require a large amount of tedious manual labor to perform.

However, machine learning models may be vulnerable to malicious prompts within the input provided to the models. For example, with text-based machine learning models, the input text may include a prompt that instructs the model to ignore prior instructions and/or training. Based on such a prompt, the machine learning model may generate an output that is harmful to other users and/or an organization that manages the machine learning model. For instance, the output may include protected information or information that violates content guidelines. Thus, the malicious prompts may essentially “hijack” the model by causing it to perform unintended actions.

For text-based machine learning models, preventing such malicious activity may involve including instructions in the prompt that prevent the model from generating harmful/undesirable outputs. However, many image-based machine learning models (e.g., image captioning models, optical character recognition models, visual question answering models, and/or the like) are not configured to process text that is provided as input. As a result, it is impossible with existing techniques to use such prompt-based guardrails with these image-based machine learning models, which may leave the models vulnerable to hijacking by malicious parties.

Existing techniques for securing image processing machine learning models from malicious activity may involve scanning input images to detect malicious content. For example, a separate machine learning model may be used to identify malicious content within an image before the image is provided to the image processing machine learning model. However, these scanning techniques may require a significant amount of computational overhead. For example, a machine learning model that is configured to identify malicious content in an image may require even more computational resources than the image processing machine learning model to process a given image. Thus, adding a malicious content identification model to the image processing pipeline may more than double the amount of computational resources required to process an image. Furthermore, such scanning models may fail to identify malicious content in images.

Thus, there is a need in the art for improved techniques of securing image processing machine learning models.

### BRIEF SUMMARY

Certain embodiments provide a method of securing image processing machine learning models. The method generally includes: receiving an input image; injecting a protective patch into the input image to produce a patched image, wherein the protective patch comprises security instructions that prevent an image processing machine learning model from performing a target action; providing the patched image to the image processing machine learning model; and receiving an output from the image processing machine learning model based on the patched image.

Other embodiments provide processing systems configured to perform the aforementioned method as well as those described herein; non-transitory, computer-readable media comprising instructions that, when executed by one or more processors of a processing system, cause the processing system to perform the aforementioned method as well as those described herein; a computer program product embodied on a computer readable storage medium comprising code for performing the aforementioned method as well as those further described herein; and a processing system comprising means for performing the aforementioned method as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of a patched image that may be provided to an image processing machine learning model.

FIG. 2 depicts an example of computing components related to securing image processing machine learning models.

FIG. 3 depicts an additional example of computing components related to securing image processing machine learning models.

FIG. 4 depicts example operations related to securing image processing machine learning models.

FIG. 5 depicts an example of a processing system for securing image processing machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for securing image processing machine learning models.

According to certain embodiments, before an image is provided as input to an image processing machine learning model (e.g., an image captioning model, an optical character recognition model, a visual question answering model, and/or the like), a protective patch is injected into the image. The protective patch may include instructions that prevent the model from following malicious instructions that are included in the image. For example, the malicious instructions may be designed to cause the model to generate content that violates moderation guidelines or reveal protected information. Because the protective patch prevents the model from following the malicious instructions, malicious parties may be unable to hijack the model to perform tasks that are contrary to the training and configuration of the model.

Embodiments of the present disclosure provide numerous technical and practical effects and benefits. For example, injecting a protective patch into an input image allows for input-based guardrails to be used with image processing machine learning models. The input-based guardrails, which were previously only compatible with models that accept text as input, may prevent malicious parties from hijacking the models using malicious instructions included in images. Furthermore, the techniques disclosed herein may be more reliable and efficient than existing techniques for securing image processing machine learning models. For example, injecting a protective patch into each image provided to a model may require significantly less time and resources than scanning each image for malicious content (e.g., using a separate machine learning model that is trained to detect malicious content in images). Additionally, while techniques that rely on detecting malicious content may fail to detect malicious items in images, embodiments disclosed herein may effectively prevent all model hijacking attempts. Also, while some embodiments provide that the image processing machine learning model may be trained based on the security patches to provide enhanced security against hijacking, techniques disclosed herein alternatively allow for establishing effective guardrails without modifying the image processing machine learning model (e.g., by training or fine-tuning the model based on patches).

### Example of a Patched Image That May Be Provided to an Image Processing Machine Learning Model

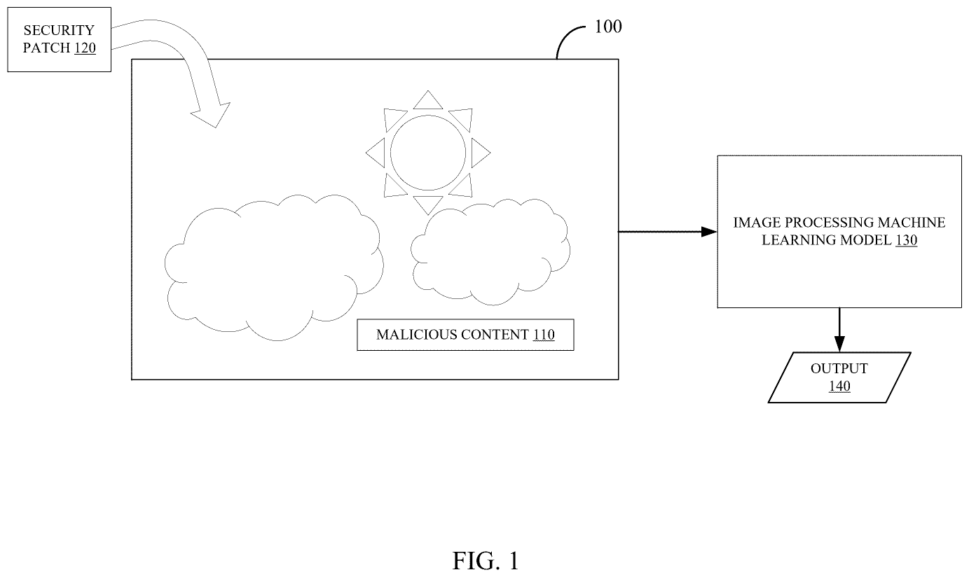

FIG. 1 depicts an example of a patched image that may be provided to an image processing machine learning model.

The image 100 may generally be any type of image that may be processed by an image processing machine learning model. For example, the image 100 may comprise a file that contains values for different pixels of the image 100.

The image 100 may include malicious content 110. The malicious content 110 may be any type of prompt that is designed to affect the performance of an image processing machine learning model 130. The malicious content 110 may comprise instructions to perform an action that is harmful/undesirable (otherwise referred to as a target action). For instance, the malicious content 110 may instruct the model 130 to ignore prior instructions and/or training. The malicious content 110 may instruct the model 130 to generate content that violates guidelines put in place by the host of the model 130. In some instances, malicious content 110 may instruct the model 130 to reveal protected information. The malicious content 110 may be hidden within the image 100 (i.e., in a manner that makes the malicious content undetectable to humans/detection systems but still readable by the model 130). For example, stenographic techniques may be used to conceal the malicious content 110 in the pixels of the image so that the malicious content 110 is not visible to humans or other scanning systems. As another example, the malicious content 110 may be represented as an embedding vector or other machine-readable format that may avoid detection but may otherwise be understood by the model 130.

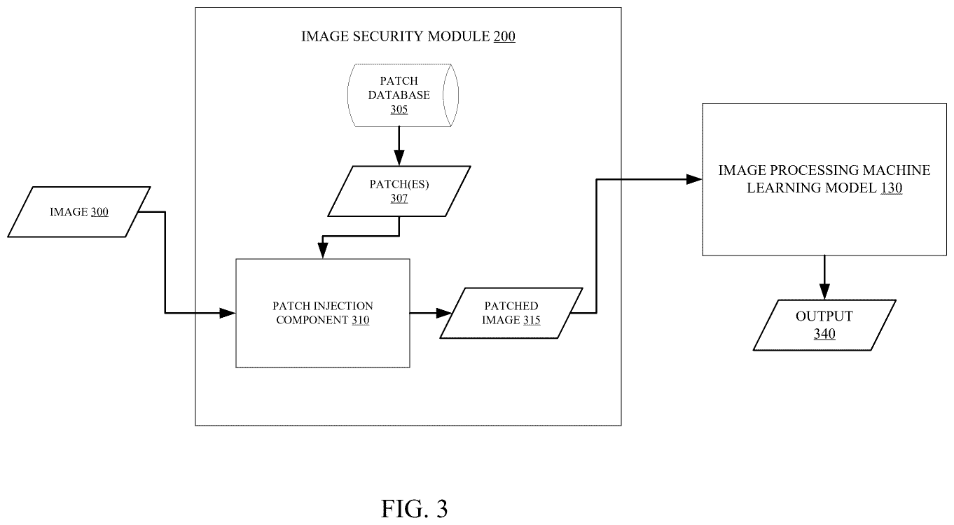

As described in further detail below with respect to FIG. 3, a security patch 120 may be injected into the image 100 to prevent the model 130 from following instructions found in the malicious content 110. The security patch 120 may include security instructions that prevent the model 130 from following other instructions found in the image 100. For example, to prevent the model 130 from generating an output that includes protected content or content that violates guidelines, the security instructions in the protective patch may instruct the model not to disclose the protected information and/or not to generate content that violates the guidelines. In some embodiments, the security patch 120 comprises natural language instructions. Alternate embodiments provide that the security patch is written in a machine-readable format such as an embedding vector. In certain embodiments, the security patch may be added to the image using stenographic techniques. Injecting the security patch 120 into the image 100 may comprise generating a new version of the image 100 that includes the security patch 120. For example, the security patch 120 may be included in the pixels of the image 100 (e.g., overlaid on the original image 100 or embedded within the original image 100 using a stenographic technique). As another example, if the model 130 is configured to process the metadata of images, the security patch 120 may be included in the metadata of the image 100.

The image processing machine learning model 130 may be an image-based machine learning model such as an image captioning model (e.g., a Bootstrapping Language-Image Pre-training for Unified Vision-Language Understanding and Generation (BLIP) model, a Contrastive Language-Image Pre-training (CLIP) model), an optical character recognition (OCR) model, a visual question answering (VQA) model, and/or the like). The image processing machine learning model 130 may be configured to accept images, but not text, as input. Because the security patch 120 is added to the image 100 before the image is provided to the model 130, the model 130 may generate an output 140 that does not follow the instructions in the malicious content 110. In example embodiments, the output 140 may comprise a description of the image 100, items extracted from the image 100, an indication of an item within the image 100 that provides the answer to a question, and/or the like.

### Example Computing Components Related to Securing Image Processing Machine Learning Models

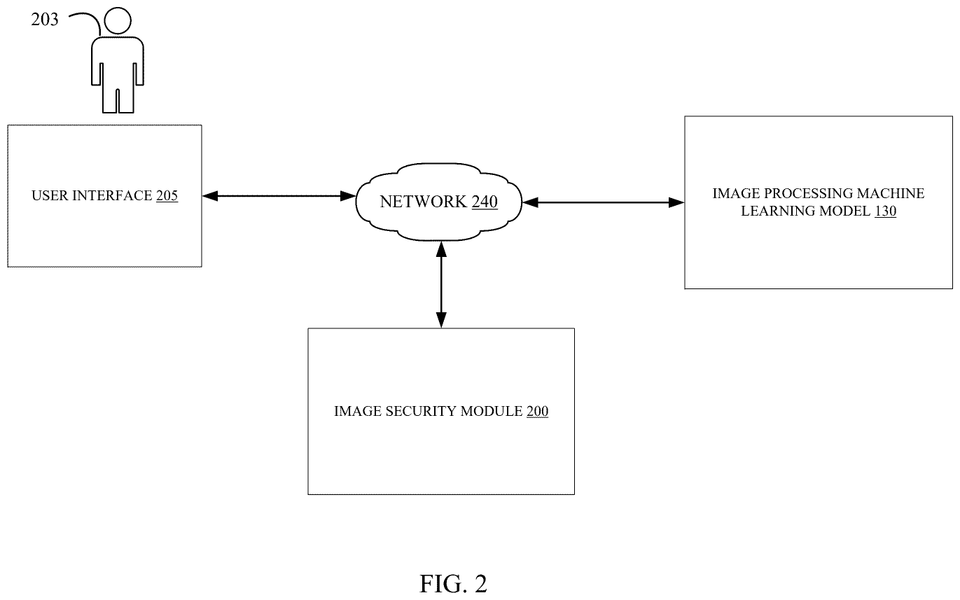

FIG. 2 depicts an example of computing components related to securing image processing machine learning models.

A user 203 may interact with a computing environment via a user interface 205 associated with a computing device. The computing environment may, for example, comprise a software application that allows the user 203 to submit images and receive an output based on the submitted images. The user 203 may submit an image that includes malicious content in an attempt to bypass the guardrails associated with the software application.

The software application may use an image security module 200 to inject a security patch into the image provided by the user 203. The security patch may prevent an image processing machine learning model 130 from generating an undesired output (e.g., an output that violates content guidelines, discloses protected information, and/or the like). When provided with the patched image (i.e., the image that contains the security patch), the image processing machine learning model 130 may generate an output that complies with the guardrails contained within the security patch. This output may be provided to the user 203.

The computing device associated with the user interface 205, the image security module 200, and the image processing machine learning model 130 may interact over network 240. Network 240 may be any connection over which data may be transmitted. In one example, network 240 is the Internet.

FIG. 3 depicts an additional example of computing components related to securing image processing machine learning models. In particular, FIG. 3 depicts functionality associated with image security module 200 of FIG. 2 in greater detail.

An image 300 may be received and provided to an image security module 200. The image 300 may include malicious content such as instructions that are designed to cause an image processing machine learning model 130 to perform harmful/undesirable actions (e.g., generating content that violates guidelines, reveals protected information, and/or the like).

The image security module 200 may be implemented by one or more processors associated with a computing device. The image security module 200 may comprise a patch injection component 310. The patch injection component 310 may retrieve one or more patches 307 from a patch database 305. The patches 307 may comprise security instructions that prevent the image processing machine learning model 130 from performing the harmful/undesirable actions prompted by the malicious content in the image 300.

In some embodiments, the patch injection component 310 selects patches 307 based on the type of the image processing machine learning model 130 and/or the use case for which the model 130 is used. For instance, a first type of model may be more susceptible to generating inappropriately violent descriptions than a second type of model. As a result, the patch injection component 310 may inject a patch into an image that includes instructions not to depict, describe, or endorse any form of violence if the image will be provided to a model of the first type. Similarly, patches may be chosen based on use cases. For example, if a model is configured to describe content, the model may be more susceptible to revealing the system prompt and/or training information than if the same model is configured to extract information from images. Thus, if the model is configured to describe content, the patch injection component 310 may generate a patch that includes instructions not to reveal the system prompt or any other prompt.

Certain embodiments provide that new patches may be created automatically based on newly identified malicious content. For example, a new type of malicious content may be included in an input image, and a patch that addresses the instructions found in this malicious content may not exist. An operator of the image processing machine learning model 130 may identify the malicious content based on an undesirable output being generated. The operator may provide the input image and a label indicating the malicious content to a language processing machine learning model (LLM) that is trained to generate new security patches based on identified malicious content. The trained LLM may then generate a new security patch that addresses the new malicious content. According to some embodiments, new malicious content may be identified using automated techniques (e.g., a machine learning model may be used to scan images output from the image processing machine learning model 130 for undesirable attributes). The automated malicious content scanning may be used on a subset of outputs generated by the image processing machine learning model 130 (e.g., outputs may be randomly selected for scanning, one in every N outputs may be scanned, and/or the like).

Patch injection component 310 may inject the patch 307 into the image 300 to generate a patched image 315. Injecting the patch 307 may comprise overlaying the patch 307 into the image 300. According to certain embodiments, injecting the patch may involve using a stenographic technique to embed the patch 307 into the image 300. For example, the least significant bits of pixels within the image 300 may be modified such that the model 130 can recognize the security instructions as a hidden stenographic message within the image 300. In some embodiments, injecting the patch 307 may comprise inserting the patch 307 into the metadata of the image 300.

Certain embodiments provide that the placement of the patch 307 within the image 300 is based on the weights of the model 130. The weights of an image processing machine learning model may be trained/configured such that certain regions of an image have a larger impact on the output of the model than other regions. For example, an area near the middle of an image may be associated with relatively large weights. As a result, this area may have a significant impact on the output of the model. By contrast, and area in the bottom left corner of the image may be associated with relatively low weights. As a result, the area near the bottom left corner may have a relatively insignificant impact on the output of the model. Accordingly, if a patch 307 is placed in the middle of the image, the model may be more likely to follow the security instructions in the patch 307 than if the patch 307 were placed in the bottom left corner of the image. Thus, the patch injection component 310 may place the patch 307 in the image 300 based on the weights of the model 130. For example, the patch injection component 310 may identify one or more weights in the model 130 that are above a threshold (e.g., the highest weights may be identified), and the patch may be injected into the image 300 at a location that corresponds to these weights. Accordingly, the location at which the patches 307 are injected may be dynamically updated based on the weights of the model(s) used.

The patched image 315 may be provided as input to the image processing machine learning model 130, and the model 130 may generate an output 340 based on the patched image 315. For example, the image 300 may be processed through layers and nodes of the model 130 based on the weights of the model 130 until the output 340 is generated.

Some embodiments provide that the image processing machine learning model 130 is trained based on the patches 307 to improve the ability of the model 130 to recognize the patches 307 and follow the instructions inside the patches 307. The image processing machine learning model 130 may be trained based on supervised, unsupervised or semi-supervised learning techniques. Supervised learning techniques generally involve providing training inputs to a machine learning model. The machine learning model processes the training inputs and outputs predictions based on the training inputs. The predictions are compared to known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Model parameters adjusted during training may include, for example, hyperparameters, values related to numbers of iterations, weights, functions used by nodes to calculate scores, level of randomness, and/or the like. In some embodiments, validation and testing are also performed for a machine learning model, such as based on validation data and test data, as is known in the art. It is noted that “training” as used herein may refer to initial training, re-training, and/or fine tuning of a machine learning model.

A supervised learning process for the image processing machine learning model 130 may comprise providing a training input to the image processing machine learning model 130. The training input may comprise an image with a protective patch and malicious instructions. Parameters of the image processing machine learning model 130 may be iteratively adjusted until an output of the model 130 complies with the instructions in the protective patch and does not comply with the malicious instructions (or until another related condition is met, such as based on a loss function as discussed above). Accordingly, the image processing machine learning model 130 may be tailored to the specific structure, format, and/or content of the patches, and may thus be better able to follow the instructions of the patches (as well as ignore instructions in malicious content).

### Example Operations Related to Securing Image Processing Machine Learning Models

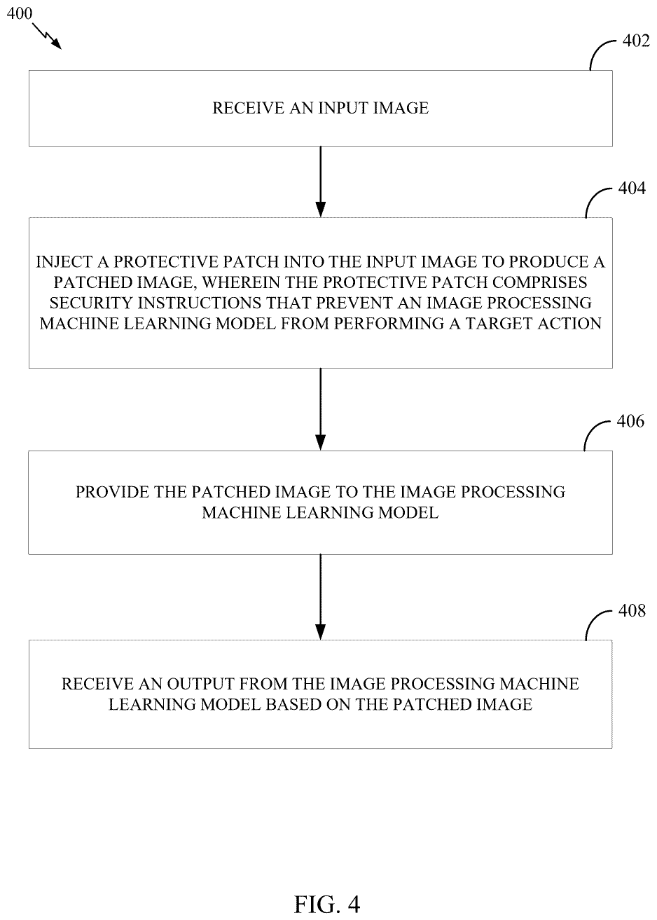

FIG. 4 depicts example operations 400 related to securing image processing machine learning models. For example, operations 400 may be performed by one or more of the components described with respect to FIG. 1, FIG. 2, and FIG. 3.

Operations 400 begin at step 402 with receiving an input image. According to some embodiments, the input image includes malicious instructions configured to cause the image processing machine learning model to perform the target action.

Operations 400 continue at step 404 with injecting a protective patch into the input image to produce a patched image, wherein the protective patch comprises security instructions that prevent an image processing machine learning model from performing a target action. In certain embodiments, the security instructions are included in the protective patch based on a type associated with the image processing machine learning model. According to some embodiments, the security instructions are included in the protective patch based on a use case associated with the image processing machine learning model. Certain embodiments provide that the patched image comprises an altered version of the input image that includes the security instructions as plain text in pixels of the input image. In certain embodiments, the patched image comprises an altered version of the input image that includes the security instructions in metadata of the input image. According to certain embodiments, the patched image comprises an altered version of the input image that includes the security instructions in a machine readable format in pixels of the input image. In certain embodiments, the target action comprises generating an output that includes protected information or information that violates content guidelines.

Operations 400 continue at step 406 with providing the patched image to the image processing machine learning model. In some embodiments, the image processing machine learning model is trained based on the protective patch.

Operations 400 continue at step 408 with receiving an output from the image processing machine learning model based on the patched image.

According to some embodiments, a location within the image at which the protective patch is injected is selected based on weights of the image processing machine learning model.

### Example of a Processing System for Securing Image Processing Machine Learning Models

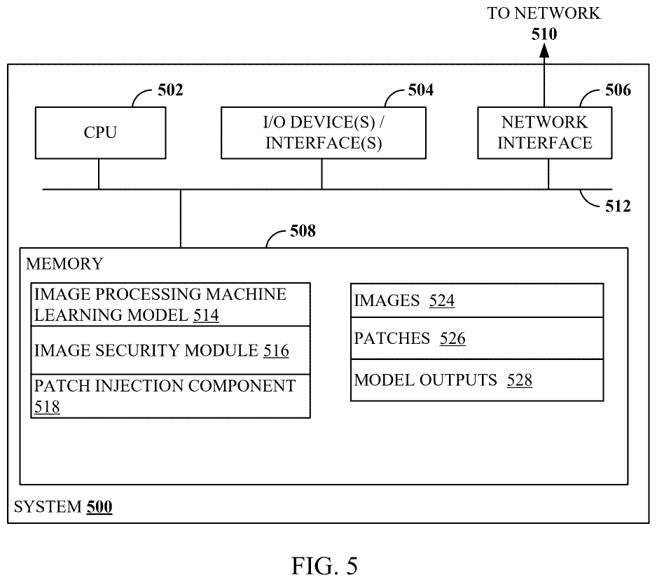

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes image processing machine learning model 514, image security module 516, and patch injection component 518. Image processing machine learning model 514 may be representative of image processing machine learning model 130 of FIG. 1, FIG. 2, and FIG. 3. In some embodiments, image security module 516 may be representative of image security module 200 of FIG. 2 and FIG. 3. Patch injection component 518 may be representative of patch injection component 310 of FIG. 3.

Memory 508 further comprises images 524, which may correspond to image 100 of FIG. 2 or image 300 or patched image 315 of FIG. 3. Memory 508 further comprises patches 526 which may correspond to security patch 120 of FIG. 1 as well as patch(es) 307 of FIG. 3. Memory 508 further comprises model outputs 528 which may correspond to output 140 of FIG. 1 as well as output 340 of FIG. 3.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of securing image processing machine learning models, comprising:
receiving an input image;
injecting a protective patch into the input image to produce a patched image, wherein the protective patch comprises security instructions that prevent an image processing machine learning model from performing a target action;
providing the patched image to the image processing machine learning model; and
receiving an output from the image processing machine learning model based on the patched image.

2. The method of claim 1, wherein the input image includes malicious instructions configured to cause the image processing machine learning model to perform the target action.

3. The method of claim 1, wherein the image processing machine learning model is trained based on the protective patch.

4. The method of claim 1, wherein the security instructions are included in the protective patch based on a type associated with the image processing machine learning model.

5. The method of claim 1, wherein the security instructions are included in the protective patch based on a use case associated with the image processing machine learning model.

6. The method of claim 1, wherein the patched image comprises an altered version of the input image that includes the security instructions as plain text in pixels of the input image.

7. The method of claim 1, wherein the patched image comprises an altered version of the input image that includes the security instructions in metadata of the input image.

8. The method of claim 1, wherein the patched image comprises an altered version of the input image that includes the security instructions in a machine readable format in pixels of the input image.

9. The method of claim 1, wherein a location within the image at which the protective patch is injected is selected based on weights of the image processing machine learning model.

10. The method of claim 1, wherein the target action comprises generating an output that includes protected information or information that violates content guidelines.

11. A system for securing image processing machine learning models, comprising:
one or more processors; and
a memory comprising instructions that, when executed by the one or more processors, cause the system to:
receive an input image;
inject a protective patch into the input image to produce a patched image, wherein the protective patch comprises security instructions that prevent an image processing machine learning model from performing a target action;
provide the patched image to the image processing machine learning model; and
receive an output from the image processing machine learning model based on the patched image.

12. The system of claim 11, wherein the input image includes malicious instructions configured to cause the image processing machine learning model to perform the target action.

13. The system of claim 11, wherein the image processing machine learning model is trained based on the protective patch.

14. The system of claim 11, wherein the security instructions are included in the protective patch based on a type associated with the image processing machine learning model.

15. The system of claim 11, wherein the security instructions are included in the protective patch based on a use case associated with the image processing machine learning model.

16. The system of claim 11, wherein the patched image comprises an altered version of the input image that includes the security instructions as plain text in pixels of the input image.

17. The system of claim 11, wherein the patched image comprises an altered version of the input image that includes the security instructions in metadata of the input image.

18. The system of claim 11, wherein the patched image comprises an altered version of the input image that includes the security instructions in a machine readable format in pixels of the input image.

19. The system of claim 11, wherein a location within the image at which the protective patch is injected is selected based on weights of the image processing machine learning model.

20. A non-transitory computer readable medium comprising instructions that, when executed by one or more processors of a computing system, cause the computing system to:
receive an input image;
inject a protective patch into the input image to produce a patched image, wherein the protective patch comprises security instructions that prevent an image processing machine learning model from performing a target action;
provide the patched image to the image processing machine learning model; and
receive an output from the image processing machine learning model based on the patched image.
